(19) United States
(12) Patent Application Publication
(10) Pub. No.: US 2006/0180553 A1
(43) Pub. Date: Aug. 17, 2006

(54) Method for filtering fluids and device for implementing said method

(76) Inventor: Werner Pfeiffer, Guldental (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/563,954

(22) PCT Filed: Jul. 9, 2004
(86) PCT No.: PCT/EP04/07579

§ 371 Date: Jan. 10, 2006

(30) Foreign Application Priority Data
Jul. 11, 2003 (DE) 103 31 383.4

(51) Int. Cl. B01D 25/28

(52) U.S. Cl. 210/772; 210/224

(57) ABSTRACT

The invention relates to a method for filtering fluids, wherein an input (22) for the unfiltrate and an output (24) for the filtrate, in addition to a plurality of stackable frame parts (16), more particularly in the form of filtrate plates (26) and filter frames (28) are provided, wherein each filter frame (28) defines a filtrate space (30) for receiving a filter cake that builds up, said filter frame being closed by a layer filter (32) on the side facing the next frame part (16) in the stack, wherein the filtrate space (30) with the collectable filter cake is defined by another filtration medium (34) on the side opposite the layer filter (32), wherein another fluid, particularly in the form of a washing fluid, is supplied by means of this other filtration medium (34), said washing fluid coming out of the device through an output (24) after flowing through the filter cake and the adjacent layer filter (32). The invention also relates to a device for implementing the inventive method.

The invention relates to a method for filtering fluids, one input for the unfiltered material and one output for the filtrate as well as a plurality of stackable frame parts being provided, especially in the form of filtrate plates and filter frames, the respective filter frame bordering the filtrate space for accommodating a forming filtrate cake, which on its side facing the next frame part in the stack is sealed by a laminar filter, and the filtrate space with the filter cake which can be accommodated being bordered on its side opposite the laminar filter by another filter medium. The invention furthermore relates to a device for implementing said method.

EP 1 140 317 B 1 discloses a device which is likewise used for continuous filtration of fluids by means of a pressure drop between an inlet and outlet of the device and for squeezing the remaining amounts of unfiltered material by means of a pneumatic pressurized medium before opening the device having
a plurality of filter plates in the form of a filter frame, which on both sides have a recess for holding a flat filter medium and are provided with drain channels for the filtrate,
a plurality of membrane plates likewise designed as a filter frame with ports, holes, and recesses for supply of the pressurized medium and being covered on both sides with an elastic membrane, between the filter medium and the membrane a space for unfiltered material or filter cake being formed, the membranes which can be elastically stretched when exposed to pressure up to flat contact with the filter plates or the laminar filter material having a smooth surface on both sides, and in the relieved state adjoining the membrane plate over the entire surface,
a frame which borders the unfiltered material space between the membrane plates and the filter plates,
corresponding recesses in the filter plates and membrane plates which in the installed state form at least one respective feed channel for the unfiltered material and one respective drain channel for the filtrate, and having
end plates, holding, and fastening devices to detachably connect the filter plates and membrane plates to each other as a filter frame into a package.

This known filter device with respect to its structural design is considered to be a so-called filter press, but is used in the filtration process like a plate filter in which the filtrate is pressed through the filter medium by the fluid pressure drop between the inlet and outlet. As the filter medium the known solution uses sections of a laminar filter material which is characterized by a labyrinth-like deep-bed filter structure which optionally permits both mechanically and also adsorptively influenced separation of particles on the relatively long path through the filter medium in conjunction with different surface charges. Such laminar filter materials which are also referred to as filter layers are special cardboards for filtration of fluid media with the objective of separating coarse to extremely fine particles, colloids, microorganisms, and other undesirable components in order to obtain a filtrate of the desired high quality, and to obtain solid residues as filter cake.

Although very good separation results can be achieved with the known solution to devices and processes, it still leaves something to be desired, especially concerning the separation of extremely fine particles, such as albumin, globulin, protein substances, or the like from a blood plasma fluid or using the known solution for processes and devices for blood-plasma fractionation. In spite of squeezing by means of the membranes of the individual membrane plates within the filter device, active substances which are then lost for the further treatment processes can remain in the filter cake; this leads to losses on the cost side especially for very expensive products of active substances, such as albumin, globulin, and/or other special protein substances.

EP 0 759 318 A1 discloses a generic process and a device which serve the purpose of dehydration and drying of solid/fluid mixtures in which the slurry to be treated is dehydrated in a filter press and the filter cake which is formed is dried by supplying heat, the filter cake formed in dehydration being pressed on each side against heating plates mounted between and parallel to two respective filter plates which are heated to a constant drying temperature. Pressing the filter cake against the surfaces of the heating plates is effected by means of a pressurized gas which is delivered by way of a collecting pipe and a drain, after heating the filter cake to a specified temperature the supply of the pressurized gas being stopped and a flushing gas under a low pressure being fed into the filter press and drawn off by way of the drain and collecting pipe. Switching from the pressurized gas (preheating phase) to flushing gas (vaporization phase) and vice versa is repeated until the desired degree of drying of the cake is achieved, whereupon the dried filter cake is removed conventionally by opening the filter press. In the known solution therefore two filter media always border one collecting space in which the heating rod is guided, and with the known solution it is possible on the one hand to jointly filter by way of the two filter media and to flush them jointly with a washing liquid (pressurized gas) supplied by way of a slurry feed. In this configuration as well it cannot be precluded that active substances will remain in particular in the middle area of the filter cake and will thus be lost for more extensive treatment processes.

On the basis of this prior art, the object of the invention is therefore to further improve the known solutions such that as few active substances as possible remain in the filter cake and are thus not lost for more extensive treatment processes in order in this way to increase the cost efficiency of a filtration process, especially as regards extremely fine separation processes. This object is achieved by the process with the features of claim 1 and a device with the features of claim 7.

In that, as specified in the characterizing part of claim 1, another fluid, especially in the form of a washing liquid, is fed through the other filter medium, which liquid after flowing through the filter cake and the bordering laminar filter leaves the device by way of its output, by way of a suitable washing liquid which can vary in terms of its ingredients as a function of the filtration task, valuable substances and active substances remaining for example in the filter cake can be washed out in this way and accordingly supplied to the filtrate side of the device in order to be available for further processing and treatment. In that compared to the most similar known solution the washing liquid is supplied by way of a filter medium, then flows completely through the filter cake located in the collecting space, and only then is discharged by way of the other filter medium which likewise borders the collecting space, it is ensured that potentially expensive filtrate products, such as protein substances, albumin, globulin, etc., are routed out of the device on the filtrate side on the outlet side so that the filtration performance with the process solution as claimed in the invention is increased compared to the known solutions and the cost efficiency for the individual filtration processes is clearly increased by obtaining additional active substances.

By using a washing liquid which is routed in this way by way of a filter medium prior to its entry into the filter cake, an especially careful separation process of the active substances from the filtrate cake is also achieved; this is a factor especially when the active substances are sensitive to mechanical loads, for example in the form of the pressure of the membrane of a membrane plate or the like. For processes of selective separation of active substances by means of the washing liquid, by using a laminar filter on one side of the filter cake and by using another filter medium on the opposing side of the filter cake with the corresponding flow through the filter layers and the complete filter cake by means of the washing liquid, it is thus possible to completely omit mechanical processes of squeezing out the filter cake and to still achieve good separation rates for the active substance. A device with the configuration of features of claim 7 is used to implement the process described in the foregoing.

In one preferred embodiment of the device as claimed in the invention, the laminar filter is formed from a deep-bed filter medium and the other filter medium is formed by a filter cloth or likewise from a deep-bed filter medium. Selectivity for the extremely fine substances to be separated can be defined by the suitable choice of filter cloths and/or deep-bed filter materials.

In another preferred embodiment of the process as claimed in the invention, a compressive force is applied to the other filter medium such that the filter cake is pressed in the direction of the laminar filter. Preferably to apply a compressive force to the other filter medium a membrane is used which can be exposed to a pressurized medium, especially in the form of a gas, and which is a component of a membrane plate as another flame part of the device with which the process as claimed in the invention can be implemented. Especially in the case of extremely fine substances which are less sensitive to mechanical compressive stress can the yield of separation products then be increased in this way by the filtrate cake being not only washed, but compressed when provided with a compressive pressure. In this way the yield of active substances on the filtrate side can be increased during the filtration process. Depending on the solution selected, it is possible to first compress the filter cake and then wash it; to implement these processes in a reversed sequence or at the same time to wash and to press the filter cake concomitantly, the washing liquid effecting separation from one filter to the next adjacent one in a homogenous, uniform flow.

In another especially preferred embodiment of the process as claimed in the invention, the laminar filter and the other filter medium are clamped between the plate-like frame parts, their covering the channels of the unfiltered material and filtrate which are connected to the input and output of the device. The respective filter layers and filter media can be tensioned between the frame parts and thus fixed within the device. Accordingly it is not necessary, as described in the prior art (EP 1 140 317 B1) to insert the filter medium into recesses of the respective filter plate in order to then compress the sections of laminar filter material along the edge side between the filter plates and frame to form a seal. This results in frame parts with a complex structure and therefore to an increase in production costs of the device.

The device as claimed in the invention for implementing the described process is the subject matter of claim 7.

The process as claimed in the invention is detailed below using a device and different embodiments as shown in the drawings. The figures are schematic and not to scale.

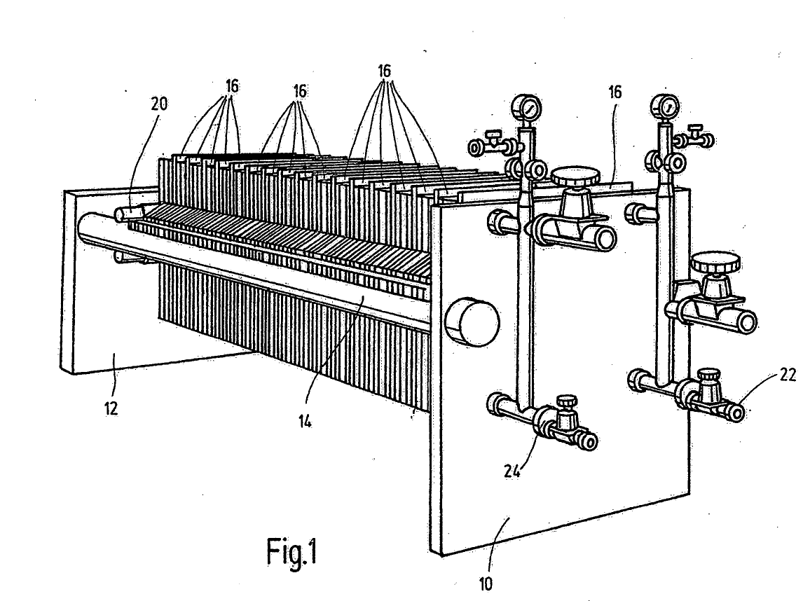

FIG. 1 shows a perspective of one face of the device;

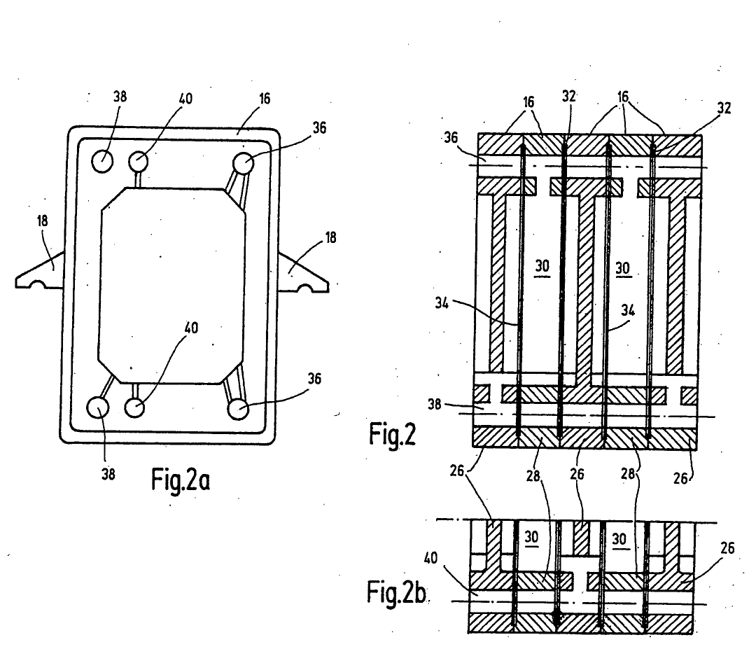

FIGS. 2, 2a and 2b show cross sections through one part of the stacked package of frame parts and a front top view of one frame part;

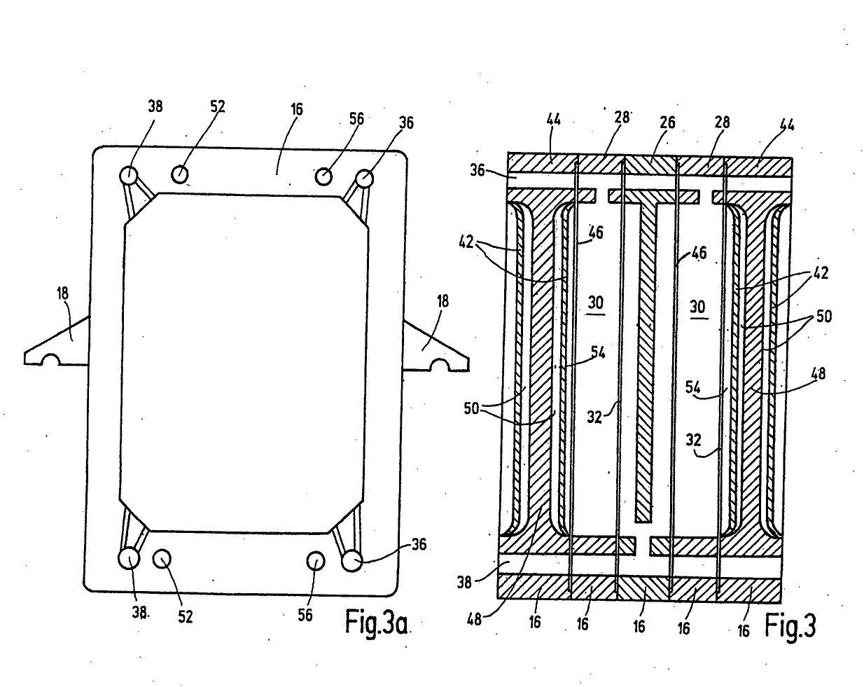

FIGS. 3, 3a in turn show a cross section through the stacked frame parts of a second embodiment and a front view of this frame part;

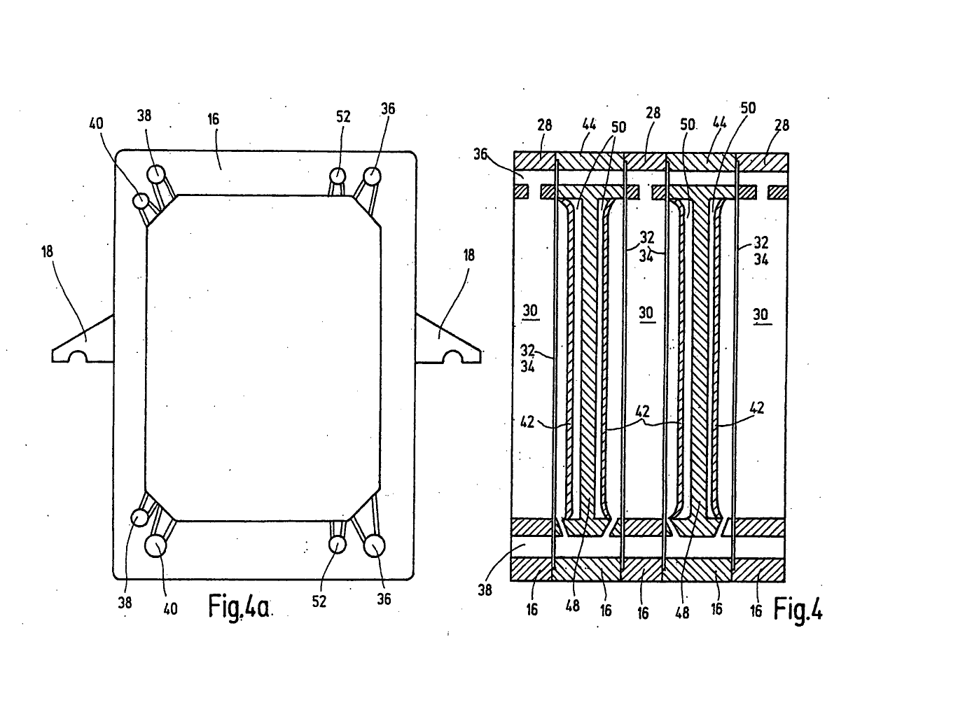

FIGS. 4, 4a show a cross section through the stacked frame parts of a third embodiment and a front view of this frame part.

The filter device as claimed in the invention which is shown in perspective in FIG. 1 has a front and a rear mounting plate 10 and 12. The two mounting plates 10, 12 are held against each other in a horizontal plane by way of a beam-like support frame 14. Frame parts 16 with the support projections 18 molded onto them can be stacked from overhead on the support frame 14 and forced into compressive contact with each other. So that the individual frame parts 16 are held in their position on the support frame 14, on one end of the device a pressing means 20 (not detailed) acts on the device and keeps the plate-like frame parts 16 against each other. On the front mounting plate 10 in the form of a connection there is furthermore one input 22 for feed of the unfiltered material and one output 24 for the discharge of the filtrate. The structure of this filter device is conventional and verifiable in a plurality of designs and embodiments in the prior art so that it will not be detailed here. Furthermore, the device shown in FIG. 1 can have ports (not detailed) which are not further specified for delivery of the pressurized medium, washing liquid and optionally additional channels and connecting points for the filtrate and unfiltered material.

In the embodiment shown in FIGS. 2, 2a and 2b, the frame parts 16 in an alternating sequence form filtrate plates 26 on the one hand and filter frames 28 on the other, the respective filter frame 26 bordering a filtrate space 30 for holding a filter cake which is not detailed and which forms during filtration. This filtrate space 30 is sealed on its one side by a laminar filter 32 and on its side opposite the laminar filter 32 as a further boundary has another filter medium 34 which is likewise a laminar filter in this embodiment. A deep-bed filter layer as is specified by the prior art is used as the filter medium of the respective laminar filter 32, 34.

This deep-bed filter layer is disclosed for example in DE 100 44 218 A1. This known solution is a filter which is equipped to be wet-proof, with a high swelling capacity in particular, which comprises a filter matrix which contains cellulose fiber and which has open-pore cavities, the cellulose fibers on their surface having chemically bonded polyisocyanate. In one preferred embodiment the known filter matrix has finely distributed microparticles in its cavities in order to facilitate extremely fine separation processes. As a result of the native fiber structure of the fiber matrix with cellulose fibers in this design, shrinkage processes can occur with subsequent drying or sintering of the matrix, with the result that in spite of intensified swelling behavior technically exact definition of the filtration properties is not possible.

Conversely, DE 102 29 291 proposes an improved filter material in the form of a deep-bed filter layer, consisting of a support layer which forms passages, with a first type of plastic fibers and with a definable proportion of native fibers, the first type of fibers being made as bicomponent fibers having a core with a high melting point, which core is surrounded by a jacket with a conversely lower melting point, in the filter material there being a wet-proofing agent, selected from the group of epichlorohydrin resins and/or melamine formaldehyde resins. This results in an essentially shrink-free, stable filter matrix structure with reliable connecting points with which constant filtration properties can be achieved, as well as extremely fine separation processes in order to be able to separate extremely small parts, such as microorganisms or proteins and protein substances from fluid solutions. The deep-bed filter layers indicated in the foregoing are therefore especially suited for the present filter device as claimed in the invention. The solution as claimed in the invention is furthermore characterized in that the filter media 32, 34 extend cloth-like with an essentially square cross section over the frame parts 16 and in this way can be fixed by pressing between two frame parts 16.

In the embodiment shown in FIG. 2 the unfiltered material is supplied by way of the input channels 36 to the individual frame parts 16 in the stack sequence (compare also FIG. 2a). The respective unfiltered material then flows by way of the input channels 36 into the filtrate space 30 and there passes through the laminar filter 32 and the laminar filter 34 on both sides. The filtrate is then drained by way of output channels 38, 40 which are mounted in succession in the horizontal plane, the other output channel 40 being shown in FIG. 2b in another section plane from FIG. 2. As is furthermore to be seen in FIG. 2a, the configuration of output channels 38, 40 is doubled, specifically extending at the top and bottom on the frame parts 16 and extending essentially in a horizontal plane to the input channels 36 for the unfiltered material. If at this point the filter cake has built up sufficiently in the respective filtrate space 30, it still has corresponding contents which have not been filtered out, and in order to recover these substances, the filter cake in the filtrate space 30 is washed out. For this purpose a washing liquid which is not detailed is supplied on the input side by way of the filter output 38, and after passing through the filtrate plates 26, the filter medium 34, the filtrate cake in the filtrate space 30 and the laminar filter 32, the washing liquid with the active substances obtained by washing travels into the filtrate plate part 26 which is the middle one viewed in the direction of looking at FIG. 2 and from there drainage by way of the output channel 40 takes place. In this process the specific configuration permits careful washing of the filter cake uniformly over the surface. Furthermore, with this configuration the active substances can be obtained especially carefully without other pressurized media, so that for extremely fine substances which react sensitively to mechanical loading, the configuration of the filter package as shown in FIG. 2 is recommended.

The following embodiments as shown in FIGS. 3 and 4 are described below only to the extent that they differ essentially from the preceding embodiments.

Furthermore, the same components are provided with the same reference numbers and what was stated above in this respect also applies to the other embodiments.

In particular, the other two embodiments as shown in FIGS. 3 and 4 differ from the embodiment as shown in FIG. 2 in that for pressing of the filter cake they use a pressurized medium, especially in the form of a pressurized gas, which acts on a membrane 42 of a membrane plate 44 which as another frame part 16 in the stack is added to the other frame parts in an alternating sequence according to the embodiment shown in FIG. 2.

In the embodiment shown in FIG. 3, on the right one respective deep-bed filter medium as the respective laminar filter 32 is inserted toward the edge-side boundary of the filtrate space 30 viewed in the direction of looking at FIG. 3. On the opposite side, this time a filter cloth 46 of conventional structure as another filter medium borders the filtrate space 30. As FIG. 3 furthermore shows, along one middle plane the respective membrane plate 44 has two membranes 42 which are separated by one chamber wall 48. Between the chamber wall 48 and the respective membrane adjacently opposite, a pressure space 50 is formed by delivering and draining a pressurized fluid by way of the pressure channels 52 (compare FIG. 3a) the respective membrane 42, for example in the form of a rubber-elastic membrane, being pressed in the direction of the adjacently opposite filter cloth wall 46, the respective filter cloth 46 being provided with a definable fluid permeability. Furthermore, the respective membrane 42 with the filter cloth 46 assignable thereto borders a washing chamber 54 which can be supplied with a definable washing liquid by way of other channels 56 (compare FIG. 3a).

In this solution the unfiltered material (suspension) in turn is supplied to the device by way of the two channels 36 and is delivered to the filtrate space 30 and separated from the solid. Then the fluid coming from the filtrate space 30 flows through the deep-bed filter layer 32 and is then collected by means of the respective filtrate plate 26 and drained through the two filtrate channels 38. After filtration, the solid collected in the filtrate space 30 of the filter frame 28 can be squeezed using the membranes 42 if a pressurized medium is supplied to the device by way of the pressure channels 52. Next the filter cake in the filtrate space 30 in the pressed state is washed, the washing liquid being supplied to the device by way of the other two channels 56 (compare FIG. 3a) for this purpose. This washing liquid is then distributed by way of the free space or the washing chamber 54 between the respective pressing membrane 42 and the filter cloth 45 as another filter medium and is pressed in an equal area through the filter cake in the filtrate space 30. Then the washing liquid passing through the deep-bed filter layer in the form of a laminar filter 32, is collected in the filtrate plate 26 and then drained by way of the filtrate channels 36. Since in all these sequences it is not necessary to deform the deep-bed filter layer 32, reliable and optimum filtration and washing of the cake with the device as claimed in the invention are ensured.

In the embodiment as shown in FIGS. 4, 4a, the filtrate plates 26 basically are designed as membrane plates 44 and furthermore the filter medium is preferably an elastically structured laminar filter 32 or a filter cloth 34 as another filter medium. The unfiltered material is in turn supplied from the top and bottom to the respective frame part 16 by way of the input channel 36 and the filtrate is drained by way of the output channels 38, 40 likewise at the top and bottom on the respective frame part 16. The pressurized fluid is delivered and drained by way of the pressure channels 52 (compare FIG. 4a) and the pressurized fluid or gaseous medium travels in this way into the pressure space 50 between the chamber wall 48 and the membrane 42. This time the output 40 of the filtrate is available as the input for the washing liquid and output of the washing liquid takes place by way of the output channels 38 of the other filtrate. In this way there is the possibility, on the basis of alternation, of specifically squeezing the respective solid cake in the filtrate space 30 from one side or the other by way of the respective membrane 42 and in doing so washing the cake at the same time.

Optimized washing of the cake for the respective solid cake within the device is achieved with these solutions, on the one hand with mechanical pressure application by way of the pressure membrane and on the other hand without. With the solution as claimed in the invention extremely fine substances, such as protein substances, albumin, and globulin can be carefully and economically filtered out of fluids within the scope of blood-plasma fractionation.

In order to ensure sealing of the filtration system to the outside a circumferential closed seal (not shown) is present between the relevant frame parts in the respective clamping plane. Furthermore this seal can be configured on the respective edge-side termination of the filter medium integrally thereon. To the extent filtrate spaces are discussed in the application, they are partially also designated as “unfiltered material space” in technical language so that the terms correspond to each other and can be equated to each other in this respect.

1. Method for filtering fluids, one input (22) for the unfiltered material and one output (24) for the filtrate as well as a plurality of stackable frame parts (16) being provided, especially in the form of filtrate plates (26) and filter frames (28), the respective filter frame (28) bordering the filtrate space (30) for accommodating a forming filtrate cake, which on its side facing the next frame part (16) in the stack is sealed by a laminar filter (32), and the filtrate space (30) with the filter cake which can be accommodated being bordered on its side opposite the laminar filter (32) by another filter medium (34), characterized in that another fluid, especially in the form of a washing liquid, is fed through this other filter medium (34), which fluid after flowing through the filter cake and the bordering laminar filter (32) leaves the device by way of its output (24).

2. The process as claimed in claim 1, wherein the laminar filter (32) is formed from a deep-bed filter medium and the other filter medium (34) is formed by a filter cloth (46) or likewise from a deep-bed filter medium.

3. The process as claimed in claim 1, wherein a compressive force is applied to the other filter medium (34) such that the filter cake is pressed in the direction of the laminar filter (32).

4. The process as claimed in claim 1, wherein to apply the compressive force to the other filter medium (34) a membrane (42) is used which can be exposed to a pressurized medium, especially in the form of a pressurized gas or a pressurized fluid, and which is a component of a membrane plate (44) as another frame part (16).

5. The process as claimed in claim 1, wherein the laminar filter (32) and the other filter medium (34) are clamped between the plate-like frame parts (16), and wherein they leave uncovered the channels of the unfiltered material and filtrate (36; 38, 40) which are connected to the input (22) and output (24).

6. The process as claimed in claim 5, wherein the other medium, especially in the form of the washing liquid, is supplied and drained by way of the filtrate channels (38, 40) and/or separate channels (56) in the frame parts (16).

7. Device for implementing a process as claimed in claim 1, for filtering fluids one input (22) for the unfiltered material and one output (24) for the filtrate as well as a plurality of stackable frame parts (16) being provided, especially in the form of filtrate plates (26) and filter frames (28), the respective filter frame (28) bordering the filtrate space (30) for accommodating a forming filtrate cake, which on its side facing the next frame part (16) in the stack is sealed by a laminar filter (32), and the filtrate space (30) with the filter cake which can be accommodated being bordered on its side opposite the laminar filter (32) by another filter medium (34), wherein another fluid, especially in the form of a washing liquid, is fed through this other filter medium (34), which fluid after flowing through the filter cake and the bordering laminar filter (32) leaves the device by way of its output (24).
